(19) United States
(12) Patent Application Publication
(10) Pub. No.: US 2002/0162977 A1
(43) Pub. Date: Nov. 7, 2002

(54) Optical radiator coating sensor

(76) Inventor: P. Edward Clugston JR., Windham, ME (US)

Correspondence Address: Woodard, Emhardt, Naughton, Moriarty and McNett, Bank One Center/Tower, 111 Monument Circle, Suite 3700, Indianapolis, IN, 46204-5137, US

(21) Appl. No.: 10/131,749

(22) Filed: Apr. 24, 2002

Related U.S. Application Data
(60) Provisional application No. 60/286,159, filed on Apr. 24, 2001.

(51) Int. Cl. G01V 8/00; G01N 21/86

(52) U.S. Cl. 250/559.19

(57) ABSTRACT

A detector for measuring the reflectivity of a pollution reduction coating, including a housing, a substantially transparent window formed in the housing, a light source operationally connected in the housing and adapted to shine out the window onto the coating and a photodetector assembly operationally connected in the housing. The photodetector assembly includes a first photodetector positioned to receive light from the light source reflected by the coating, a second photodetector positioned to receive light from the light source reflected only from the window, and a third photodetector positioned to receive light directly from the light source. The first and second photodetectors are substantially blocked from receiving light directly from the light source and the second photodetector is substantially blocked from receiving light from the light source reflected by the coating. The third photodetector is substantially blocked from receiving light from the light source reflected by either the window or by the coating.

### REFERENCE TO RELATED APPLICATION

The present application claims priority to U.S. Provisional Patent Application Serial No. 60/286,159 filed Apr. 24, 2001.

### BACKGROUND OF THE INVENTION

Since the beginning of the industrial revolution, pollutants such as hydrocarbons, ozone and carbon monoxide have been increasingly expelled into the atmosphere. While recent efforts to reduce emissions of these atmospheric contaminants have resulted in a slowdown of the amount of pollutants going into the atmosphere, little has been done to decrease the concentration of contaminants already present in the environment. Recently, catalytic coatings have been developed that eliminate these pollutants upon contact. Specifically, catalyst coatings have been developed that, upon contact, reduce hydrocarbons to carbon dioxide and water, carbon monoxide to carbon dioxide, and/or ozone to O₂. These coatings are particularly effective in high temperature environments enjoying substantial airflow. Consequently, automobile radiators and air conditioning condensers are chief among the obvious places to apply the coatings to clean the air.

The newly developed catalyst coatings are discussed in U.S. Pat. Nos. 6,190,627 and 6,214,303 to Hoke et al., and 5,997,831 to Dettling et al., all assigned to the Englehard Corporation of Iselin, N.J., and incorporated by reference herein in their entirety. The catalysts are generally comprised of either precious metals, metal oxides, or combinations thereof, and can be tailored to address one or more type of pollutant. For example, ozone may be treated with a catalyst composition of manganese oxides such as Mn₂O₃ and/or MnO₂. The combination of MnO₂ and CuO is another effective ozone-treating compositions. Also effective is a platinum layer formed on a support layer of coprecipitated zirconia and manganese oxide.

Some catalyst compositions useful for the conversion of carbon monoxide into carbon dioxide include the deposition of a platinum group metal such as platinum, palladium, rhodium, ruthenium, gold and silver or a combination thereof onto a refractory metal oxide support layer. One such composition known to be particularly effective is a reduced platinum group metal formed on a titania support layer.

Unsaturated hydrocarbons from C₂ to C₂₀ or so and C₂ to C₈ mono-olefins may be eliminated through the use of catalysts such as a platinum group metal such as platinum formed on a refractory metal oxide support layer, such as titania, alumina or manganese dioxide. One such composition known to be particularly effective is a reduced platinum group metal formed on a titania support layer.

A precious metal component formed on a refractory metal oxide support structure can be effective towards the elimination of ozone and carbon monoxide. The refractory metal oxide may be selected from ceria, alumina, silica, titania, zirconia, and mixtures thereof. Also useful as a support material is a coprecipitate of zirconia and manganese oxides. Preferably, a reduced platinum component is formed on the refractory metal oxide support. Likewise, palladium may be selected for forming on the support structure. These catalyst structures may also be effective in the simultaneous removal of ozone, carbon monoxide and hydrocarbons from the atmosphere.

One problem shared by all of the above catalyst systems is that prolonged exposure to flowing air at elevated temperatures results in gradual ablation of the catalyst layer from the particulate matter borne in the air. Another problem is the gradual deposition of particulate matter onto the catalyst layer, thereby blocking the layer from contact with the pollutants it would otherwise catalyze. Porous coatings have been applied over the catalyst coating with some limited success at retarding the ablation of the catalyst, but such coatings are particularly susceptible to blockage by the deposition of particulate matter thereupon. There is therefore a need for a system for detecting when the catalyst layer is degraded from ablation and/or blockage. The present invention addresses this need.

### SUMMARY OF THE INVENTION

The present invention relates to an improved method and apparatus for measuring the degradation of a coating using a detector having a light source and a plurality of photodetectors in a partially transparent sensor housing. A detector is provided having a substantially opaque housing, a light source positioned in the housing and positioned to directly illuminate a first portion of the coating and a substantially transparent lens formed in the housing and positioned between the coating and the light emitting diode. A first photodiode is connected in the housing and positioned to receive light emitted by the diode and reflected from the coating. A second photodiode is connected in the housing and positioned to receive light emitted by the diode and reflected by the lens. A third photodiode is connected in the housing and positioned to receive light directly from the diode. Reflected light from the coating is measured as a function of time, and the reflectivity of the coating is calculated as a function of time with compensations made for changes in intensity of the light source and the transparency of the lens.

One object of the present invention is to provide an improved method and apparatus for the detection of the degradation of radiator coatings. Related objects and advantages of the present invention will be apparent from the following description.

### BRIEF DESCRIPTION OF THE DRAWINGS

FIG. 1 is a perspective view of a reflectivity sensor according to a first embodiment of the present invention.

FIG. 2 is a side sectional elevational view of the sensor of FIG. 1.

FIG. 3. is a rear sectional elevational view of the sensor of FIG. 1.

FIG. 4 is a schematic view of the sensor of FIG. 1 connected to a microprocessor.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

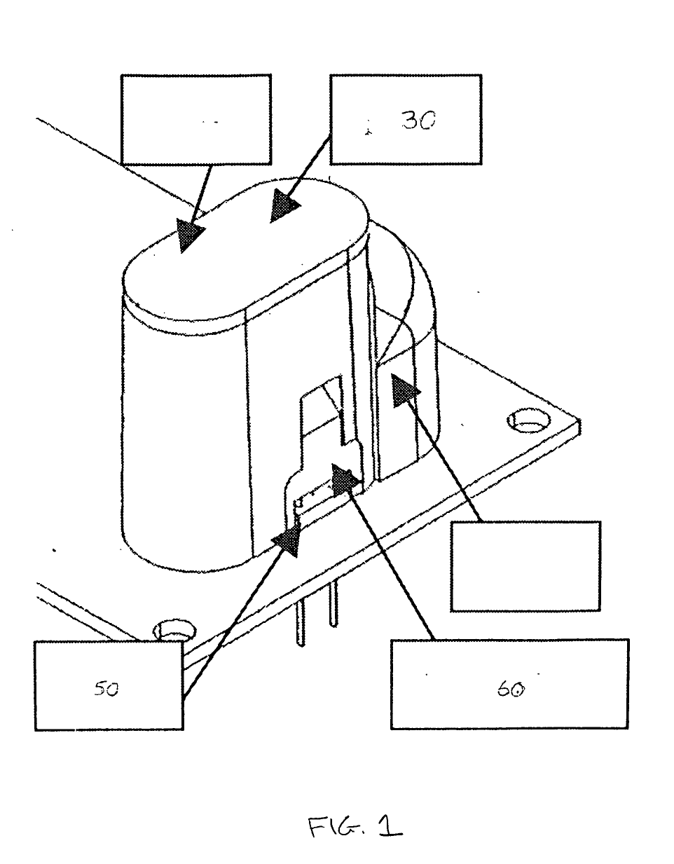

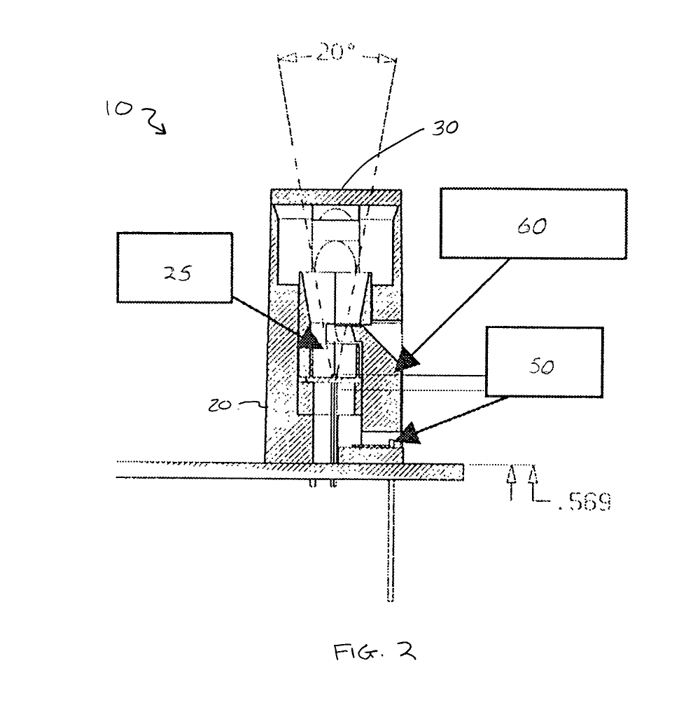

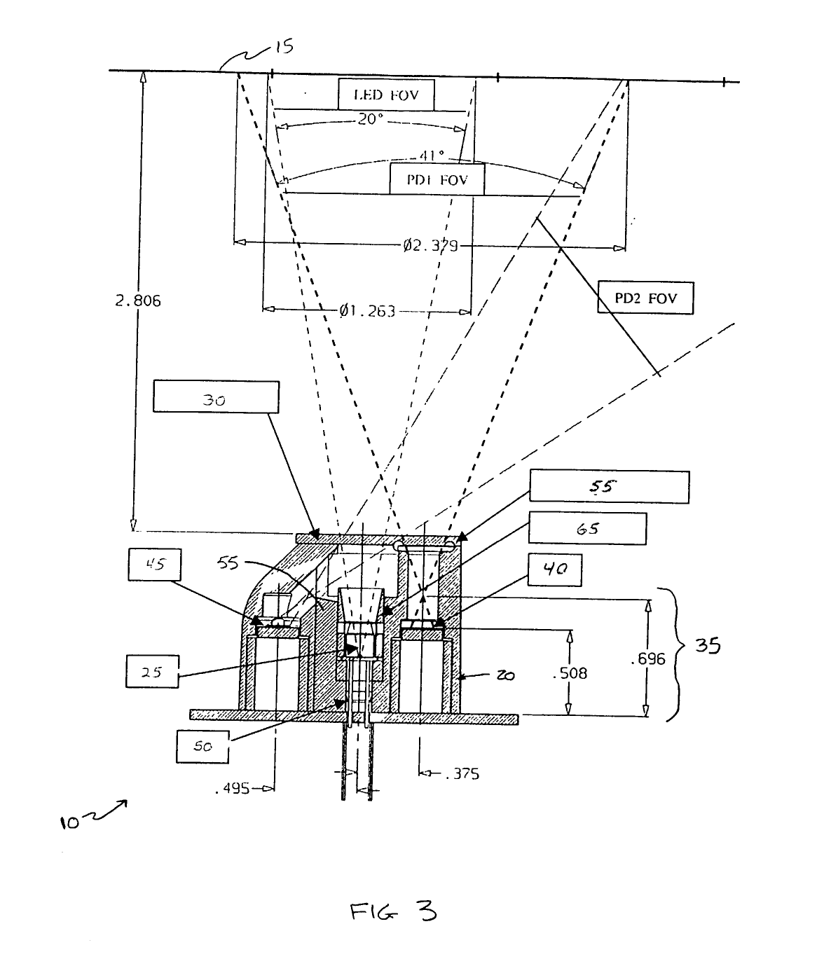

FIGS. 1-3 illustrate a first embodiment of the present invention, a reflectivity detector or sensor 10 for measuring the reflectivity of a coating, indicated generally at 15. The coating 15 is preferably a catalytic coating for the removal of pollutants from air, and is more preferably formed on a vehicular radiator. The coating 15 may have a relatively low reflectivity (such as manganese oxide-based coatings) or may have a relatively high reflectivity (such as precious metal based coatings). Preferably, the coating 15 is formed over a base layer (not shown) having a substantially different reflectivity, such that degradation by wear of the coating 15 increasingly exposes the base layer such that changes in the perceived reflectivity of the coating 15 are more readily detectable. In other words, as the coating 15 is degraded and the base layer exposed, the reflectivity contrast between the coating 15 and the base layer is readily detectable. An alternate degradation mechanism is degradation of the coating 15 by deposition of a dirt layer thereonto. Such a deposited dirt layer blocks the contact between the air (and, more particularly, the pollutants contained therein) and the catalytic coating 15. Thus measuring degradation by deposition is particularly important if the coating 15 is porous or has a porous overcoating, since such pores are easily blocked by the deposition of airborne particulates.

Sensor 10 includes a substantially opaque housing 20 having a light source 25, such as a light emitting diode (LED) mounted therein. The housing includes a substantially transparent window or lens 30 formed therein. The window 30 is positioned between the light source 25 and the coating 15, such that when energized the light source 25 shines onto the coating 15. The light source is preferably an LED, and is more preferably an LED adapted to emit primarily in the infrared band.

A photodetector assembly 35 is also mounted in the housing 20. The photodetector assembly 35 includes a first photodetector 40 positioned to receive light emitted by the light source 25 and reflected back from the coating 15. The first photodetector 40 is also positioned such that it receives no light directly from the light source 25. The second photodetector 45 is positioned to receive light internally reflected in the housing 20 by the window 30. The second photodetector 45 is further positioned to receive no light directly from the light source 25, or any light from the light source 25 reflected by the coating 15. The third photodetector 50 is positioned to receive light directly from the light source 25, but is positioned to receive no light reflected by the window 30 or coating 15. Preferably, the photodetectors 40, 45, 50 are photodiodes. However, any suitable light detection devices may be chosen as would be known to one of ordinary skill in the art.

Preferably, opaque shields 55 are positioned in the housing to block direct light from the light source 25 from reaching the first and second photodetectors 40, 45. Also preferably, a light pipe 60 is used to guide light from the light source 25 directly to the third photodetector 50. Alternately, the third photodetector 50 may be positioned such that there is a direct and unobstructed line of sight between the third photodetector 50 and the light source 25. Also, the photodetectors 40, 45, 50 may be filtered to eliminate extraneous or unwanted signals, either through integrated filters or filter elements positioned between the photodiodes 40, 45, 50 and their respected targets of observation.

A heat sink 65 is connected to the light source 25 to carry away excess heat generated thereby. The heat sink 65 is preferably an aluminum member of sufficient surface area and mass to remove sufficient heat from the light source 25 to prevent the light source 25 from overheating.

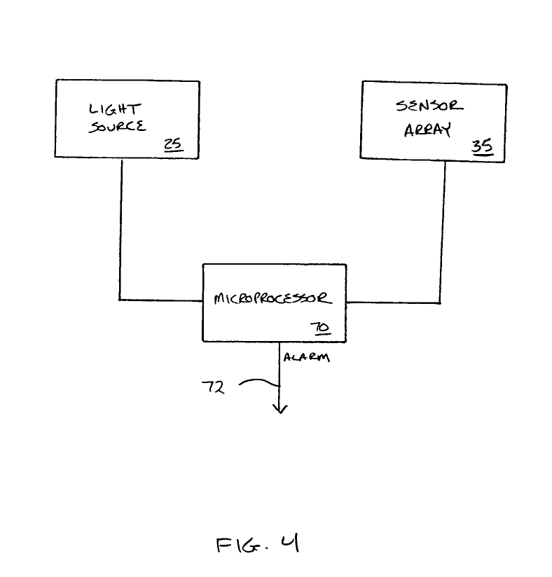

Referring to FIG. 4, a microprocessor 70 is electrically connected to the light source 25 and to the photodetector assembly 35. The microprocessor 70 is adapted to receive and record signals from the photodetector assembly 35, including coating refelctivity signals from the first photodetector 40, window reflectivity signals from the second photodetector 45, and light source intensity signals from the third photodetector 50. The microprocessor 70 is preferably programmed to calculate the intensity of the light source 25, the reflectivity of the window 30, and the reflectivity of the coating 15. The microprocessor 70 is more preferably programmed to compensate for changes in the intensity of the light source 25 and the reflectivity of the window 30 to calculate the reflectivity of the coating 15. The microprocessor 70 is still more preferably programmed to send an alarm signal 72 when the calculated coating reflectivity crosses a predetermined threshold value.

In the operation of a reflectivity sensor, there are several possible sources of error measurement, such as variations in the light source intensity and dirt on the sensor lens surface. The light source intensity can vary due to changes in ambient temperature, component-to-component variation, and component aging effects which typically cause the light source output to degrade. The effects of dirt on the lens are typically signal attenuation and scattering that occurs during both the outbound and inbound passes of light though the lens. The two major sources of signal contamination have different characteristics, in that the light source intensity affects the reflectance signal through a linear gain or attenuation, while the lens dirt affects the reflectance signal in a non-linear fashion. Light source intensity may be taken into account, either by stabilizing the source intensity by means of a feedback loop or by measuring the light source output and normalizing any variations though signal processing.

Using just one photodiode in a reflective sensor has several significant disadvantages. Since there would only be one sensing element, the main signal of interest and all of effects of variation are combined into a single signal. This composite signal contains the information resulting from the combination of the target surface reflectance signal, variations in the light source intensity and variations from dirt on the lens. Extracting just the target surface reflectance signal from the composite signal is a difficult task. This situation would be analogous to isolating just the sound of a violin from a single microphone recording of a live orchestra. All of the violin sound is included in the recording, but without having access to the isolated sounds of the other instruments and the background noise, it is nearly impossible to completely isolate just the pure sound of the violin.

Likewise, using only two photodiodes (i.e., one for the target surface reflectance signal and the other to capture the light source intensity and effects of lens dirt) is only marginally better since the two contamination signals are still combined. It is only by using three photodiodes in a reflectance sensor that the target surface reflectance signal, the lens dirt signal, and the light source intensity signal are allowed to be collected separately. The light source intensity signal is a pure signal that only contains information about the actual light source intensity. The lens dirt signal contains information about both the lens dirt and light source intensity, since the absolute level of the signal varies directly with changes in the light source intensity. Since the light source intensity signal has already been measured directly, it can be used with great confidence to isolate only the lens dirt information from the lens dirt signal. Now both the light source intensity and the lens dirt have been isolated. The actual target surface reflectance quantity can be isolated from the target surface reflectance signal by using the light source intensity quantity and the lens dirt quantity that were previously isolated. The result is the determination of the actual target surface reflectance, in spite of variations in light source intensity or lens dirt conditions.

In operation, the detector 10 may be mounting at an angle and rotation such that the field of view includes a maximized amount of the coated surface of interest. In the case of a coated automobile radiator, it may be desirable for the detector field of view to include the front and side of the radiator fins and tubes (i.e., to maximize the total target surface area and include both the outside edges and a portion of the internal surfaces of the radiator.) Increasing the distance between the detector 10 and the target surface allows a greater area to fall within the field of view. This allows for more accurate averaging of the surface reflectivity condition. Thus, a local defect such as a bent fin has a reduced effect on the output since it is averaged along with all of the other fins within the field of view.

In one preferred embodiment, the detector 10 is tested at 25° C., 55° C., 85° C., and 115° C. At each temperature the output of the detectors 40, 45, 50 in the photodetector assembly 35, as well as the temperature, are recorded. From this information three sets of slopes and offsets are established, along with a correction for the internal temperature of the detector.

Next, the sensor 10 output is measured and recorded with no target, and with the radiator targets “A”, “B”, “C”, and “D”. Each of theses five target conditions is evaluated with various amounts of dirt applied to the lens 30, starting with a clean lens 30 and progressing to increasing dirt level, as reported by the second photodetector 45 signal. The first and second photodetector 40, 45 signals are corrected for temperature, using the slopes and offsets established during the temperature calibration step.

The first photodetector 40 signal is then compensated for the lens 30 dirt level detected by the second photodetector 45, using the information collected during the dirt calibration step. The compensation required is increasingly non-linear as the dirt level increases and is at its greatest level when both the lens 30 dirt and the coating 15 reflection are highest. The non-linear correction relationship is expressed as the “x” and “x²” terms of a polynomial equation.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A detector for measuring the degradation of a coating, comprising:
a substantially opaque housing;
a light emitting diode positioned in the housing and positioned to directly illuminate a first portion of the coating;
a substantially transparent lens formed in the housing and positioned between the coating and the light emitting diode;
a first photodiode connected in the housing and positioned to receive light emitted by the diode and reflected from the coating;
a second photodiode connected in the housing and positioned to receive light emitted by the diode and reflected by the lens;
a third photodiode connected in the housing and positioned to receive light directly from the diode;
a first opaque shield formed in the housing and positioned to prevent light from the diode shining directly onto the first photodiode; and
a second opaque shield formed in the housing and positioned to prevent light from the diode shining directly onto the second photodiode;
wherein the second photodiode is positioned to view a second portion of the coating non-coextensive with the first portion of the coating.

2. The detector of claim 1 wherein the lens is characterized by a reflectivity value and wherein the reflectivity value increases with the deposition of dirt onto the lens.

3. The detector of claim 1 further comprising a microprocessor operationally connected to the diode, the first photodiode, the second photodiode and the third photodiode.

4. The detector of claim 3 wherein the microprocessor is adapted to calculate the intensity of the diode, the reflectivity of the lens, and the reflectivity of the coating.

5. The detector of claim 4 wherein the microprocessor compensates for changes in the intensity of the diode and the reflectivity of the lens to calculate the reflectivity of the coating.

6. The detector of claim 4 wherein the microprocessor sends a signal when the calculated reflectivity crosses a predetermined threshold value.

7. The detector of claim 1 further comprising a heat sink operationally connected to the diode.

8. A detector for measuring the reflectivity of a pollution reduction coating, comprising:
a housing;
a substantially transparent window formed in the housing;
a light source operationally connected in the housing and adapted to shine out the window onto the coating; and
a photodetector assembly operationally connected in the housing and further comprising:
a first photodetector positioned to receive light from the light source reflected by the coating;
a second photodetector positioned to receive light from the light source reflected only from the window; and
a third photodetector positioned to receive light directly from the light source;
wherein the first and second photodetectors are substantially blocked from receiving light directly from the light source;
wherein the second photodetector is substantially blocked from receiving light from the light source reflected by the coating;
wherein the third photodetector is substantially blocked from receiving light from the light source reflected by the window; and
wherein the third photodetector is substantially blocked from receiving light from the light source reflected by the coating.

9. The detector of claim 8 wherein the window reflects a non-zero amount of light from the light source back into the housing and wherein the window reflects more light into the housing as it becomes dirty.

10. The detector of claim 8 further comprising a microprocessor operationally connected to the light source, the first photodetector, the second photodetector and the third photodetector.

11. The detector of claim 10 wherein the microprocessor is adapted to calculate the intensity of the light source, the reflectivity of the window, and the reflectivity of the coating.

12. The detector of claim 8 further comprising a heat sink operationally connected to the light source.

13. A method for detecting the degradation of a pollution-reducing catalyst layer coating an automobile radiator, comprising the steps of:
a) measuring the reflectance of the catalyst layer as a function of time; and
b) sending a predetermined alert signal when the reflectance changes by a predetermined amount.

14. A method for measuring the degradation of a coating using a detector having a light source and a plurality of photodetectors in a partially transparent sensor housing, comprising the steps of:
aa) measuring reflected light reflected from the coating as a function of time;
bb) compensating for changes in intensity of the light source over time;
cc) compensating for changes in the transparency of the housing over time; and
dd) calculating the reflectivity of the coating as a function of time.

15. The method of claim 14 further comprising the steps of:
ee) comparing the calculated reflectivity of the coating to a predetermined threshold value.

16. The method of claim 14 further comprising the steps of:
ff) pairing the calculated reflectivity of the coating with the date the measurement was taken;
gg) storing the dated calculated reflectivity of the coating in memory; and
hh) producing a data set of time-ordered calculated reflectivity values.
